(19) United States
(12) Patent Application Publication
(10) Pub. No.: US 2007/0101207 A1
(43) Pub. Date: May 3, 2007

(54) PCI Express interface testing apparatus

(75) Inventors: Huang-Nien Lin, Tu-cheng (TW); Tai-Chen Wang, Tu-cheng (TW); Yu-Hsu Lin, San Jose, CA (US)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: HON HAI Precision Industry CO., LTD., Tu-Cheng City (TW)

(21) Appl. No.: 11/528,055

(22) Filed: Sep. 27, 2006

(30) Foreign Application Priority Data
Oct. 28, 2005 (CN) 200510100806.9

(51) Int. Cl. G06F 11/00

(52) U.S. Cl. 714/56

(57) ABSTRACT

A PCI Express interface testing apparatus for testing characteristics of signal transmissions of a PCI Express interface includes a printed circuit board, a plurality of sending signal connectors, and a plurality of receiving signals connectors. Both the sending signal connectors and the receiving signal connectors are electrically connected to the printed circuit board. A related method for testing the characteristics of signal transmissions of a PCI Express interface is also provided.

### BACKGROUND OF THE INVENTION

1. Field of the Invention

The present invention relates to a Peripheral Component Interconnect Express (PCI Express) interface testing apparatus for a motherboard.

2. General Background

PCI Express is a revolution in graphics add-in card-interconnect standards. This specification, significantly increases bandwidth between the central processing unit and graphics processing unit by enabling balanced distribution of bandwidth to those applications that require it the most.

A connection between any two PCI Express devices is known as a “link”. The PCI Express link is built around a bidirectional, serial (1-bit), point-to-point connection known as a “lane”. Transmitting and receiving pairs are separate differential-pairs for a total of 4 data wires per lane. The PCI Express link may be comprised of multiple lanes. In such configurations, the connection is labeled as x1, x2, x4, x8, x16, or x32, where the number is effectively the number of lanes. Therefore, where PCI Express x1 would require 4 wires to connect, an x16 implementation would require 16 times that amount or 64 wires. This also results in differently sized slots.

With increasing performance requirement of computers, accurate testing of characteristics of signal transmission, such as signal sensitivities, jitter tolerances, and so on, of both sending and receiving signals are needed. Testing signal transmissions through different PCI Express slots of a motherboard is needed to insure proper performance.

Therefore, appropriate devices are needed to validate the characteristics of signal transmissions of a PCI Express interface slots. A typical PCI Express interface testing apparatus can test the characteristics of signal transmissions of the sending signals of the elements adopting the PCI Express interface specification. However, the characteristics of the signal transmissions of the receiving signals cannot be tested.

What is needed, therefore, is a PCI Express interface testing apparatus which can test characteristics of signal transmission of both the sending and receiving signal elements of the interface.

### SUMMARY

In one preferred embodiment, a PCI Express interface testing apparatus for testing characteristics of signal transmissions of a PCI Express interface includes a printed circuit board, a plurality of sending signal connectors, and a plurality of receiving signal connectors. Both the sending signal connectors and the receiving signal connectors are electrically connected to the printed circuit board. A method for testing the characteristics of signal transmissions of a PCI Express interface is also provided.

Other advantages and features will become more apparent from the following detailed description when taken in conjunction with accompanying drawings, in which:

### BRIEF DESCRIPTION OF THE DRAWINGS

FIG. 1 is an isometric view of a PCI Express interface testing apparatus in accordance with a preferred embodiment of the present invention;

FIG. 2 is a side view of the PCI Express interface testing apparatus of FIG. 1 mounted on a printed circuit board in a first position and including an oscilloscope; and

FIG. 3 is similar to FIG. 2, but the PCI Express interface testing apparatus is in a second position and connected to a signal source.

### DETAILED DESCRIPTION OF THE EMBODIMENT

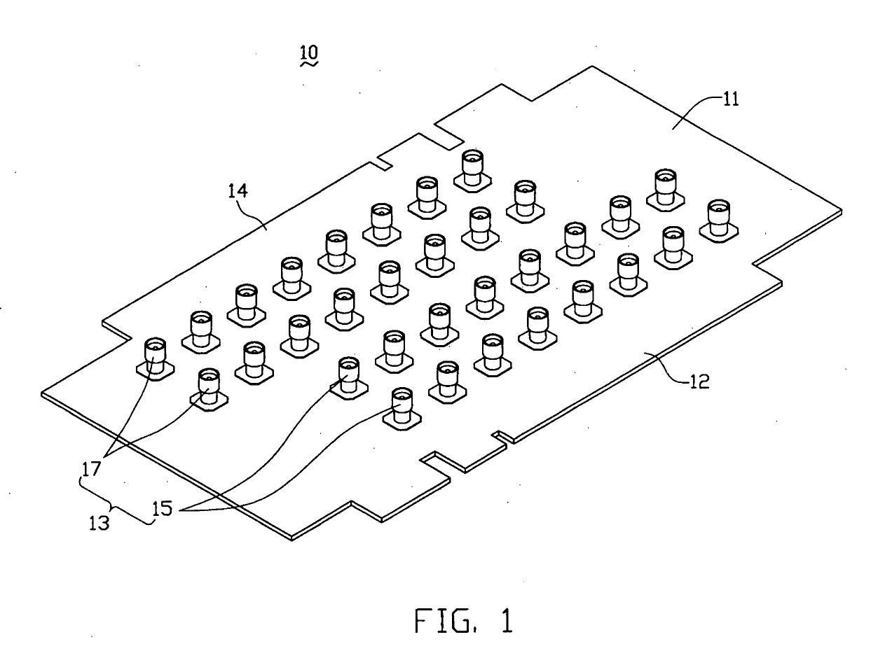

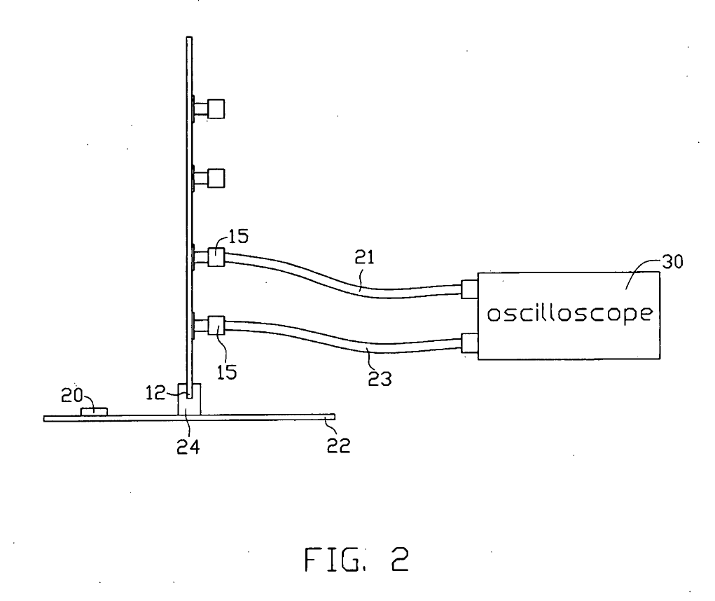

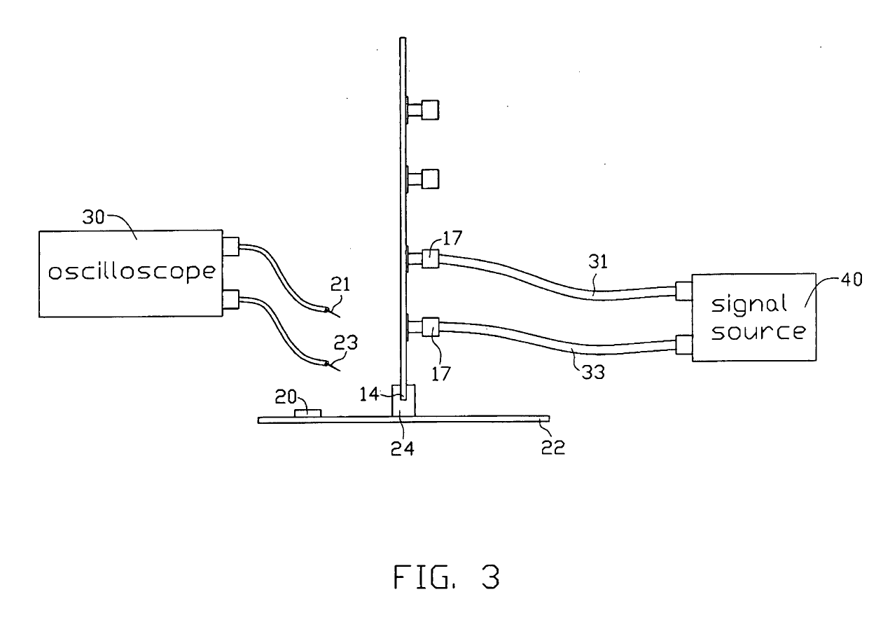

A PCI Express interface testing apparatus in accordance with a preferred embodiment of the present invention is described herein. Referring to FIGS. 1 to 3, the apparatus 10 includes a circuit substrate such as a printed circuit board (PCB) 11 and a plurality of connectors 13, the connectors 13 include a plurality of sending signal connectors 15 and receiving signal connectors 17. A test device such as an oscilloscope 30, and a signal injection device such as a signal source 40, is provided to cooperate with the apparatus 10 to test PCI Express interface slots. The connectors 15, 17 are electrically connected with the PCB 11. Typically, different elements adopting PCI Express interface specifications are connected with an electronic component such as a motherboard 22 via different sizes of PCI Express interface slots. For example, a north bridge chip 20 is on the motherboard 22. The north bridge chip 20 transmits signals via a PCI Express x16 slot 24 of the motherboard 22. The slot 24 consists of 16 lanes according to known specifications (not shown). Each lane has a sending portion and a receiving portion. In the preferred embodiment of the present invention, two similar testing printed circuit boards are needed to allow testing a group of first 8 lanes and then a group of second 8 lanes of the slot 24 respectively, any problem detected in testing is thus isolated to either the first group of lanes or the second group of lanes of the slot 24. In the following description, only the printed circuit board 11 configured with traces for connecting the connectors 15, 17 to the first group of lanes of the slot 24 via a sending interface 12 and a receiving interface 14 is explained. The other of the two PCBs is similar to the PCB 11, except the only difference is that traces therein are configured for electrically connecting connectors to the second group of lanes of the slot 24. PCI Express x1, x2, x4, x8, x32 slots can be tested in a similar manner as well, using PCBs with traces and connectors configured accordingly.

In the preferred embodiment, the sending interface 12 is formed along one side of the PCB 11, and the receiving interface 14 is formed on an opposite side thereof. The connectors 15, 17 are further arranged and connected to the PCB 11 in pairs. There are eight pairs for each of connectors 15, 17. That is one pair of connectors 15 for each sending portion and one pair of connectors 17 for each receiving portion of each lane of the first group of eight lanes.

The detail testing process is as follows: first, the sending interface 12 is inserted into the PCI Express x16 slot 24 of the motherboard 22. Then the north bridge chip 20 is activated to transmit signals via the slot 24. Probes 21, 31 of the oscilloscope 30 are then contacted with each pair (line 21 to one of the pair, line 23 to the other of the pair) of connectors 15 in turn. Readings of the oscilloscope 30 then reveal if the sending portions of the first group of lanes are operating properly.

Then, to test the receiving portions of the first group of lanes, the receiving interface 14 is inserted into the slot 24. Then the signal source 40 is activated to inject a test signal via output lines 31, 33. The probes 21, 23 of the oscilloscope 30 are connected to the north bridge chip 20 for monitoring the injected test signal. Then the output lines 31, 33 are connected to each pair (line 31 to one of the pair, line 33 to the other of the pair) of receiving connectors 17 in turn. Thus, readings of the oscilloscope 30 then reveal if the receiving portions of the first group of lanes are operating properly.

It is believed that the present embodiment and its advantages will be understood from the foregoing description, and it will be apparent that various changes may be made thereto without departing from the spirit and scope of the invention or sacrificing all of its material advantages, the example hereinbefore described merely being a preferred or exemplary embodiment.

We claim:

1. A testing apparatus for facilitating testing characteristics of signal transmissions of a PCI Express interface, the testing apparatus comprising:
a printed circuit board;
a plurality of sending signal connectors electrically connected with the printed circuit board in accordance with known PCI Express specifications; and
a plurality of receiving signal connectors electrically connected with the printed circuit board in accordance with the known PCI Express specifications.

2. The testing apparatus as claimed in claim 1, wherein one side of the printed circuit board forms a sending interface.

3. The testing apparatus as claimed in claim 2, wherein opposite to the sending interface of the printed circuit board is formed a receiving interface.

4. The testing apparatus as claimed in claim 3, wherein the sending signal connectors are used for delivering signals sent by an electronic component to a test device.

5. The testing apparatus as claimed in claim 3, wherein the receiving signal connectors are used for delivering signals sent by a signal injection device to an electronic component.

6. A method for testing characteristics of signal transmission of a PCI Express interface of an electronic component, comprising the steps of:
providing a printed circuit board;
setting a plurality of sending signal connectors and a plurality of receiving signal connectors which are both arranged on the printed circuit board;
providing a test device, connecting the sending signal connectors to both the test device and a corresponding interface slot of the electronic component, the characteristics of the sending signal transmissions of a PCI Express interface being revealed by the test device; and
providing a signal injection device, connecting the receiving signal connectors between the corresponding interface slots of the electronic component and the output ends of the signal injection device, the probes of the test device connecting to the electronic component for monitoring injected test signals, the characteristics of the receiving signal transmissions of the PCI Express interface being revealed by the test device.

7. The method as claimed in claim 6, wherein one side of the printed circuit board forms a sending interface.

8. The method as claimed in claim 7, wherein opposite to the sending interface of the printed circuit board is formed a receiving interface.

9. The method as claimed in claim 8, wherein the sending signal connectors are used for delivering signals sent by the electronic component to the test device.

10. The method as claimed in claim 8, wherein the receiving signal connectors are used for delivering signals sent by the signal injection device to the electronic component.

11. A testing apparatus comprising:
a circuit substrate;
a plurality of sending signal connectors installable at said circuit substrate and electrically connectable with said circuit substrate for transmitting sending signals of an electronic component to be tested;
a plurality of receiving signal connectors installable at said circuit substrate beside said plurality of sending signal connectors, and electrically connectable with said circuit substrate for transmitting receiving signals of said electronic component to be tested;
a first interface extending along a side of said circuit substrate and configured to be electrically connectable with said electronic component to be tested via a corresponding slot thereof, and with said plurality of sending signal connectors, respectively, for establishing signal communication between said electronic component to be tested and said plurality of sending signal connectors; and
a second interface extending along another side of said circuit substrate spaced from said first interface and configured to be electrically connectable with said electronic component to be tested via said corresponding slot thereof, and with said plurality of receiving signal connectors, respectively, for establishing signal communication between said electronic component to be tested and said plurality of receiving signal connectors.

12. The testing apparatus as claimed in claim 11, wherein said first and second interfaces, and said corresponding slot of said electronic components to be tested are compliable with standards from Peripheral Component Interconnect Express (PCI Express) specification.
